(19) United States
(12) Patent Application Publication
(10) Pub. No.: US 2004/0212170 A1
(43) Pub. Date: Oct. 28, 2004

(54) Mud, splash, and spray suppressor

(76) Inventor: Frederick William Dyer III, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/423,274

(22) Filed: Apr. 25, 2003

(51) Int. Cl. B62D 25/18

(52) U.S. Cl. 280/154

(57) ABSTRACT

The invention is an apparatus to reduce splash and spray thrown onto a motor vehicle from the tire, especially trucks.

### BACKGROUND OF THE INVENTION

1. Field of the Invention

The present invention relates to an apparatus to reduce splash and spray for motor vehicles.

2. Description of the Prior Art

During a thunderstorm or a cloud burst, rainwater falls to the road where the water pools or collects in indentations, tire tracks and channels in the road surface. This pooled water is dangerous, as it can allow hydroplaning of motor vehicles.

Equally dangerous is the spray of water from the roadway splashing motor vehicles. The motor vehicles generate clouds of spray beside or behind the vehicle as they drive down the road. The tire tread of the rotating tires contacts the road surface to lift the water and flings the water onto the fender. A lot of the splashed water ricochets off the fender back onto the tire, while some water ricochets laterally out of the well. Some of the splashed water droplets collide with other water droplets to break apart and atomize into a fine spray. This fine spray produces a fog flowing laterally from the well to decrease visibility. Spray may also include other objects on the road, such as ice, salt, pebbles and dust.

This spray residue is also thrown onto the steps, cab and vertical exhaust or exhaust stack. The thrown spray residue is a slick hazard for a driver stepping out of the cab. Furthermore, road salt and other debris can pockmark the steps, cab and exhaust tank leading to corrosion. This corrosion reduces the life of the part.

To reduce dangerous spray, various splash guards and fenders have been proposed. While these splash guards address some of the problems of splash and spray by motor vehicles, none of them adequately and efficiently protect the steps, cab and exhaust system from excessive water spray.

Outwardly extending side mounted extruded rubber fender extensions on the hood and fender, for example, extend protection beyond the width of the front tires. Side mounted fender extensions, however, create a gap between the hood mounted extension and the fender mounted extension. This gap allows splash and spray onto the hood and rear fender panel, as well as the steps and exhaust system.

Overlapping injection molded extensions mounted to the fender and hood close the gap. Due to the manufacturing constraints of injection molding, as well as their shape, these injection molded extensions cannot extend outwardly as far as the previously discussed side mounted fender extensions.

Fender extensions may also enclose the wheel well. While they reduce spray, these enclosures cause other problems. These enclosures are located outside the fenders which may increase drag on the vehicle. This increased drag decreases the vehicle's mileage.

Therefore, it is one object of the invention to provide a device to reduce splash and spray thrown rearwardly onto the steps, cab and exhaust system.

### SUMMARY OF THE INVENTION

According to the invention, there is provided an apparatus to suppress splash and spray thrown rearward from the tire of a wheeled motor vehicle, especially trucks. The invention includes a panel fastened to a bracket. The panel has opposite first and second faces. The bracket has first and second sides on the first panel face and fastens to the panel at one of the sides. A connector projects from the bracket away from the panel.

Another apparatus of the invention has a panel fastened to a bracket. A connector projecting from the bracket connects the bracket to a first support. The panel has opposite first and second faces, while the bracket has at least two sides on the first panel face and is fastened to the panel at one of the sides.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of an apparatus of the invention;

FIG. 2 is a side view of an apparatus of the invention;

FIG. 3 is an exploded perspective view of an apparatus of the invention as part of a step module; and

FIG. 4 is a perspective view of an apparatus of the invention assembled to a motor vehicle.

### DETAILED DESCRIPTION OF THE INVENTION

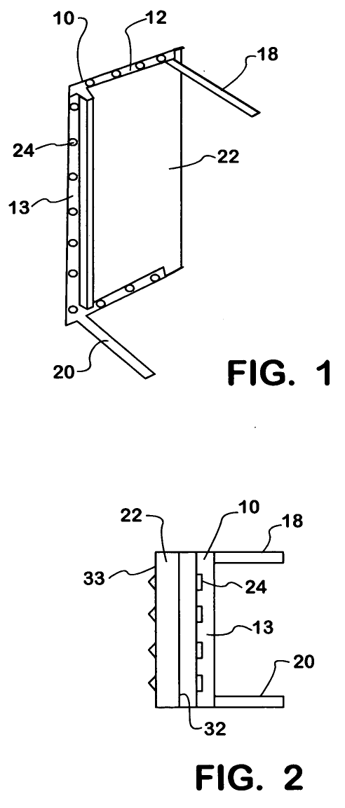

Turning to the figures where like reference numerals refer to like structures, the splash and spray suppressor is designed for a wheeled motor vehicle, especially for trucks. As shown in FIG. 1, first 12 and second 13 sides of bracket 10 are located on a face 32 of panel 22. In this embodiment, first 12 and second 13 sides are approximately perpendicular to each other to define first frame 16 of bracket 10. First side 12 can be parallel to second side 13 (not shown). Panel 22 can extend outside of bracket 10.

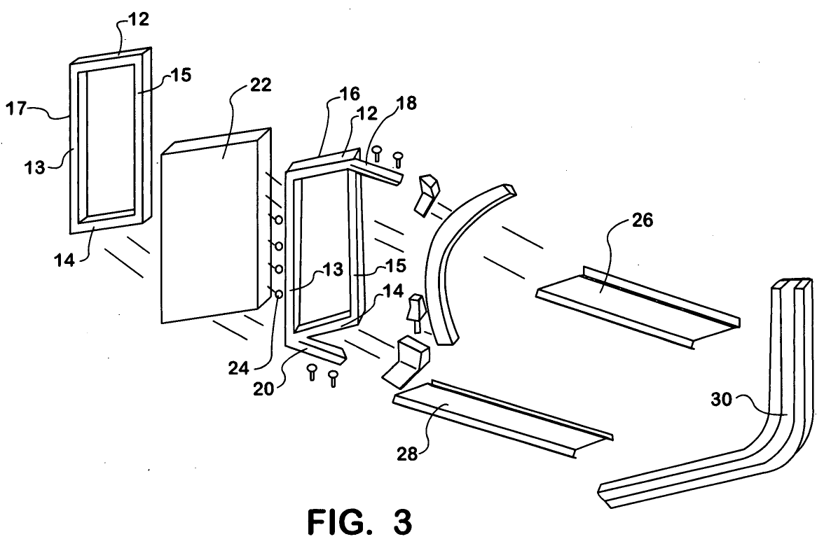

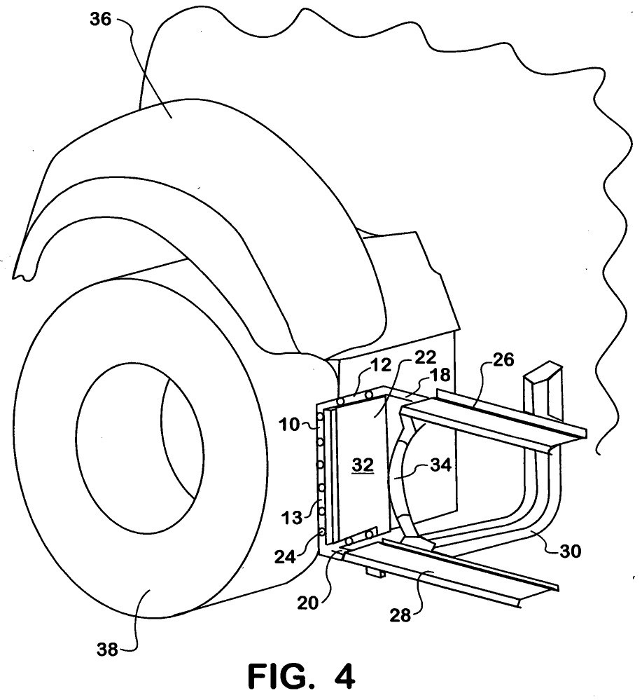

Third side 14 of bracket 10 is approximately perpendicular to either first 12 or second 13 side. Preferably, third side 14 is parallel to first side 12 and second side 13 is therebetween. Bracket 10 can also have a fourth side (FIG. 3) approximately perpendicular to either first 12 or second 13 side.

First connector 18 projects from side 12 of bracket 10 away from panel 22. First connector 18 connects to first support 26. Preferably second connector 20 projects from either second 13 or third 14 side of bracket 10 away from panel 22 to connect to second support 28.

As shown in FIG. 3, bracket 10 can have second frame 17 on second face 33 of panel 22. Second frame 17 has first 12 and second 13 sides, and can also have third and fourth sides. Panel 22 fits between first 16 and second 17 frames of bracket 10. Alternatively, first 16 and second 17 frames of bracket 10 can be at least partially assembled before sliding panel 22 into bracket 10.

Panel 22 fastens to bracket 10, typically with fasteners 24, such as bolts, Christmas tree fasteners, lag screws, and the like. The panel could also fasten to the frame by molding the panel to the frame, fusing the panel to the frame, or by welding the panel to the frame.

Panel 22 can be reinforced by a brace molded within or fused to panel 22. If a brace is used, panel 22 can fasten to bracket 10 at brace 34.

FIGS. 3 and 4 show bracket 10 with step module 30. Step module 30 has first support 26 and second support 28, both of which are preferably horizontal. Connectors 18, 20 can mount directly to supports 26, 28 respectively using fasteners. Alternatively, connector 18 and/or connector 20 can mount to mounting bracket 34 which is then fastened to at least one of the supports. Once step module 30 is assembled with bracket 10, the entire assembly attaches to motor vehicle 36 behind tire 38.

The apparatus of the invention has a number of advantages. The design of the apparatus is versatile, yet protects the step, cab and exhaust tank independent of the axle and tire widths. The same size of panel can be used with different sizes of brackets. This allows the apparatus to be used with motor vehicles of different sizes and having different axle and tire widths. In some trucks, the apparatus may eliminate the use of a mud flap.

Alternatively, different sizes of panels can be used with similar sizes of brackets, especially if the panels are reinforced. A larger panel, for example, could protect the full width of the tires.

The apparatus of the invention is efficiently assembled. The bracket and panel could be assembled independent of the motor vehicle assembly. After the apparatus is assembled, the apparatus can mount directly to the motor vehicle or to the step module. The latter allows the bracket and the step module to be mounted together to the motor vehicle during the assembly of the motor vehicle.

While the invention is shown in only one of its forms, it is not thus limited but is susceptible to various changes and modifications without departing from the spirit and scope of the invention.

What is claimed is:

1. An apparatus for a motor vehicle comprising:
a panel having opposite first and second faces;
a bracket having first and second sides on the first panel face and being fastened to the panel at one of the sides; and
a connector projecting from the bracket away from the panel.

2. An apparatus for a motor vehicle of claim 1, further comprising:
a second connector projecting from the bracket away from the panel.

3. An apparatus for a motor vehicle of claim 2, wherein the two sides are approximately perpendicular to one another and define a frame.

4. An apparatus for a motor vehicle of claim 3, further comprising:
a third side on one of the panel faces and being approximately perpendicular to one of the first two sides.

5. An apparatus for a motor vehicle of claim 4, further comprising:
a tire attached to the motor vehicle; and
wherein at least one of the connectors attaches to the motor vehicle behind the tire.

6. An apparatus for a motor vehicle of claim 5, further comprising:
a fourth side on one of the panel faces and being approximately perpendicular to one of the first two sides.

7. An apparatus for a motor vehicle of claim 5, further comprising:
a second frame being defined by sides of the bracket on the second face of the panel.

8. An apparatus for a motor vehicle comprising:
a first support;
a panel having opposite first and second faces;
a bracket having at least two sides on the first panel face and being fastened to the panel at one of the sides; and
a first connector projecting from the bracket and connecting the bracket to the first support.

9. An apparatus for a motor vehicle of claim 8, further comprising:
a second support; and
a second connector projecting from the bracket and connecting the bracket to the second support.

10. An apparatus for a motor vehicle of claim 9, wherein the two sides are approximately perpendicular to one another and define a frame.

11. An apparatus for a motor vehicle of claim 10, further comprising:
a third side on one of the panel faces and being approximately perpendicular to one of the first two sides.

12. An apparatus for a motor vehicle of claim 11, further comprising:
a fourth side on one of the panel faces and being approximately perpendicular to one of the first two sides.

13. An apparatus for a motor vehicle of claim 11, further comprising:
a tire attached to the motor vehicle; and
wherein at least one of the supports attaches to the motor vehicle behind the tire.

14. An apparatus for a motor vehicle of claim 12, further comprising:
a second frame being defined by sides of the bracket on the second face of the panel.
